(19) United States
(12) Patent Application Publication
(10) Pub. No.: US 2016/0179833 A1
(43) Pub. Date: Jun. 23, 2016

(54) RELATED INFORMATION DISPLAY METHOD AND ELECTRONIC DEVICE CAPABLE OF AUTOMATICALLY DISPLAYING RELATED INFORMATION

(71) Applicant: MStar Semiconductor, Inc., Hsinchu Hsien (TW)

(72) Inventor: Jia-Wei LIN, Hsinchu Hsien (TW)

(21) Appl. No.: 14/977,750

(22) Filed: Dec. 22, 2015

(30) Foreign Application Priority Data
Dec. 22, 2014 (TW) 103144835

(51) Int. Cl. G06F 17/30; G06F 17/22; G06F 17/27

(52) U.S. Cl. CPC G06F 17/3089; G06F 17/2775; G06F 17/2235; G06F 17/2795; G06F 17/30864

(57) ABSTRACT

A related information display method includes following steps. In step (a), a maximum word count of consecutive same words between a candidate text paragraph and a target text string to determine a similarity level. In step (b), it is determined whether to display related information of the target text string according to the similarity level. The related information is a website link associated with the target text string. The candidate text string may be dialogues in a communication software interface, text on a webpage, or text of a document in an electronic device. The target text string may be a name of a television program, a name of a place, a name of a movie, a name of a song, a name of a person, or a name of an object.

This application claims the benefit of Taiwan application Serial No. 103144835, filed Dec. 22, 2014, the subject matter of which is incorporated herein by reference.

### BACKGROUND OF THE INVENTION

1. Field of the Invention

The invention relates in general to a related information display method and an electronic device capable of automatically displaying related information, and more particularly, to a related information display method and an electronic device capable of automatically displaying related information that automatically detect and determine a similarity level between a candidate text paragraph and a target text string and display related information according to the similarity level.

2. Description of the Related Art

In current electronic devices, information searching is an extremely common and frequently used function (e.g., a search website). A conventional search method is passive, meaning that a user is required to enter a text string to activate a search. However, when using a touch electronic device (e.g., a tablet computer or a smart phone), such a search method is inconvenient since a user cannot type or copy text easily. That is to say, in the current search method, required information cannot be obtained when an incorrect text string is entered, let alone be obtained automatically.

### SUMMARY OF THE INVENTION

It is an object of the present invention to provide a related information display method and an electronic device capable of automatically displaying related information.

It is another object of the present invention to provide a related information display method and an electronic device capable of displaying correct related information when a target text string is not entirely matched.

A related information display method is disclosed according to an embodiment of the present invention. The method includes: a) detecting a maximum word count of consecutive same words between at least one candidate text paragraph and a target text string to determine a similarity level, wherein the maximum word count of consecutive same words is a word count of a longest consecutive same text string that the at least one candidate text paragraph has in the target text string, the candidate text paragraph is one of a dialogue in a communication software interface, text on a webpage and text on a document in an electronic device, and the target text string is one of a name of a television program, a name of a place, a name of a movie, a name of a song, a name of a person, and a name of an object; and b) determining whether to display related information of the target text string according to the similarity level, wherein the related information is a website link associated with the target text string.

An electronic device capable of automatically displaying related information is disclosed according to another embodiment of the present invention. The electronic device includes a screen and a control module. The control module, coupled to the screen, detects a maximum word count of consecutive same words between at least one candidate text paragraph and a target text string to determine a similarity level, and controls the screen to display related information of the target text string according to the similarity level. The maximum word count of consecutive same words is a word count of a longest consecutive same text string between the at least one candidate text paragraph and the target text string. The candidate text paragraph is one of a dialogue in a communication software interface, text on a webpage, and text on a document in an electronic device. The target text string is one of a name of a television program, a name of a place, a name of a movie, a name of a song, a name of a person, and a name of an object.

With the method and electronic device capable of automatically displaying related information according to the foregoing embodiments of the present invention, a user may conveniently learn required information or obtain a required website link. In addition, when the candidate text and the target text string are not exactly the same, the method and electronic device of the present invention are capable of automatically displaying related information. Thus, even when a user does not remember an entirely correct text string, correct related information can still be obtained.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 to FIG. 4 are schematic diagrams of a related information display method according to different embodiments of the present invention;

FIG. 5 and FIG. 6 depict different similarity levels between a candidate text paragraph and a target text string according to embodiments of the present invention;

FIG. 7 is a schematic diagram of related information of a television program;

FIG. 8 is a schematic diagram of a synonym database according to an embodiment of the present invention;

FIG. 9 is a schematic diagram of an electronic device according to an embodiment of the present invention; and

FIG. 10 is a block diagram of a control module according to an embodiment of the present invention.

### DETAILED DESCRIPTION OF THE INVENTION

A related information display method of the present invention mainly includes two steps of: detecting and determining a similarity level between at least one candidate text paragraph and a target text string; and determining whether to display related information of the target text string according to the similarity level. The related information of the target text string is displayed when the similarity level is higher than a predetermined standard. More specifically, when the candidate text paragraph includes a text string that is partially or entirely the same as the target text string, the related information of the target text string is displayed. Embodiments of the present invention are given below to better understand the present invention. It should be noted that, the embodiments are examples for illustration purposes, and are not to be construed as limitations to the present invention.

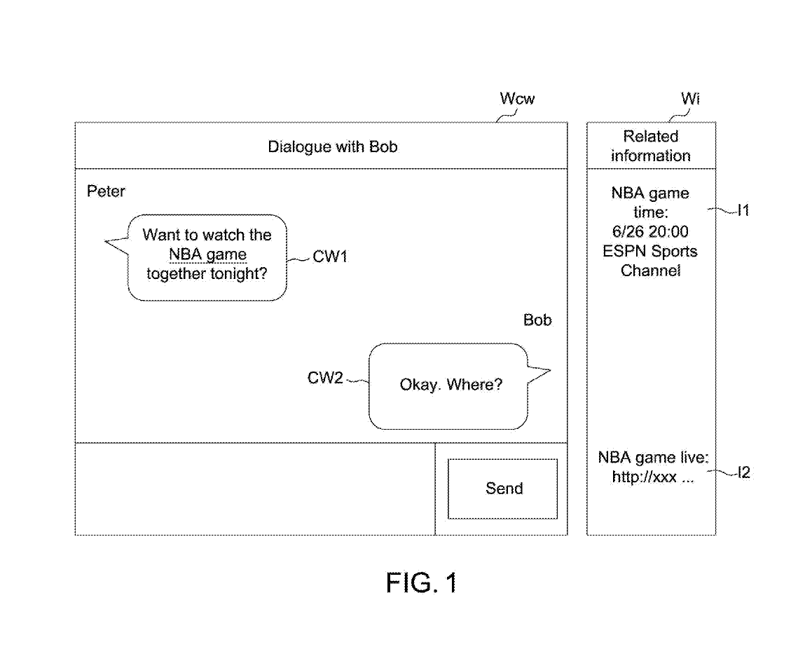

FIG. 1 to FIG. 4 show schematic diagrams of a related information display method according to different embodiments of the present invention. As shown in FIG. 1, a candidate text window Wcw is a dialogue window of two users in a communication software application, and a related information window Wi displays related information of the target text string. In the embodiment in FIG. 1, a target text string is a name of a television program “NBA game”, and candidate text paragraphs CW1 and CW2 are a dialogue between the two users. In the embodiment, as the candidate text paragraph CW1 includes the target text string “NBA game”, related information of “NBA game” is correspondingly displayed in the related information window Wi. The related information may be in various types. For example, in the embodiment in FIG. 1, an information region I1 in the information window Wi shows a broadcast time and a channel of the NBA game. An information region I2 in the information window Wi shows a broadcast link of the NBA game, and a user can watch the NBA game by directly clicking on the link. However, the related information window Wi is not limited to showing the above types of information.

It should be noted that, associated details of the candidate text window Wcw, the candidate text paragraphs CW1 and CW2, and the display method and size of the related information window Wi in FIG. 1 are merely exemplary, and the present invention is not limited herein. For example, the sizes and positions of the candidate text window Wcw and the related information window Wi may be changed on demand. Alternatively, given the candidate text paragraphs and related information can be displayed, the candidate text window Wcw and the related information window Wi may not be required at all. Further, each candidate text paragraph is not limited to one speech paragraph given by a user, and may consist multiple dialogue paragraphs, or one to multiple sentences of one dialogue paragraph.

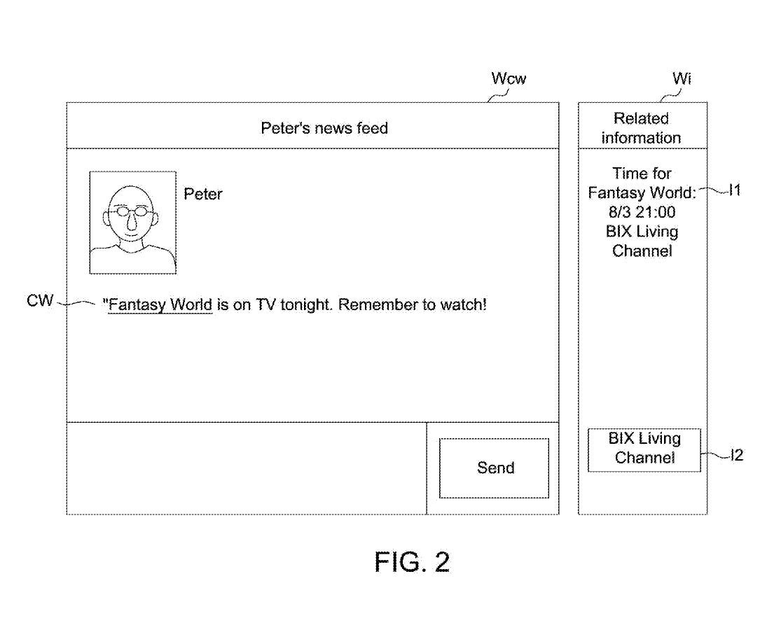

The scope of the present invention is not limited to communication software applications. For example, in the embodiment in FIG. 2, the target text string is the name of a television program “Fantasy World”, the candidate text window Wcw is a news feed of a user published on a social website, and the news feed includes the text string “Fantasy World”. Thus, the related information window Wi shows related information of “Fantasy World”. Similarly, in the embodiment, related information may be in various types. For example, the information region I1 in the information window Wi shows the broadcast time and the channel of “Fantasy World”, the information region I2 in the information window Wi shows the broadcast link of “Fantasy World”, and a user can directly watch “Fantasy World” by clicking on the link. However, the related information window Wi is not limited to showing the above types of information.

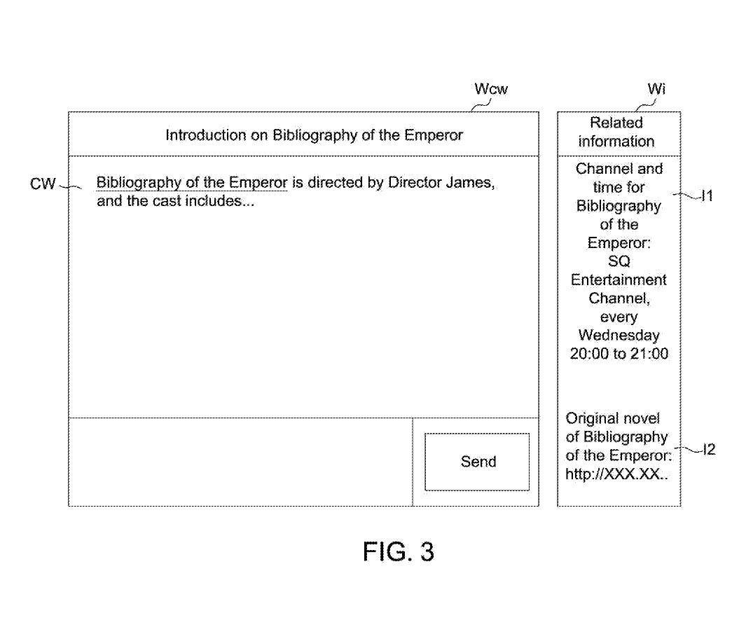

In the embodiment in FIG. 3, the candidate text window Wcw is a website window, the candidate text paragraph CW is text on a webpage, and the target text string is the name of a television program “Bibliography of the Emperor”. As shown in FIG. 3, as “Bibliography of the Emperor” appears in the candidate text paragraph CW, the related information window Wi shows related information of “Bibliography of the Emperor”. Similarly, in the embodiment, the related information may be in various types. For example, the information region I1 in the information window Wi shows the broadcast time and the channel of “Bibliography of the Emperor”, the information region I2 in the information window Wi shows a link of the original novel of “Bibliography of the Emperor”, and a user can view the original novel “Bibliography of the Emperor” or purchase information of the original novel by clicking on the link. It should be noted that, the related information Wi is not limited to showing the above types of information.

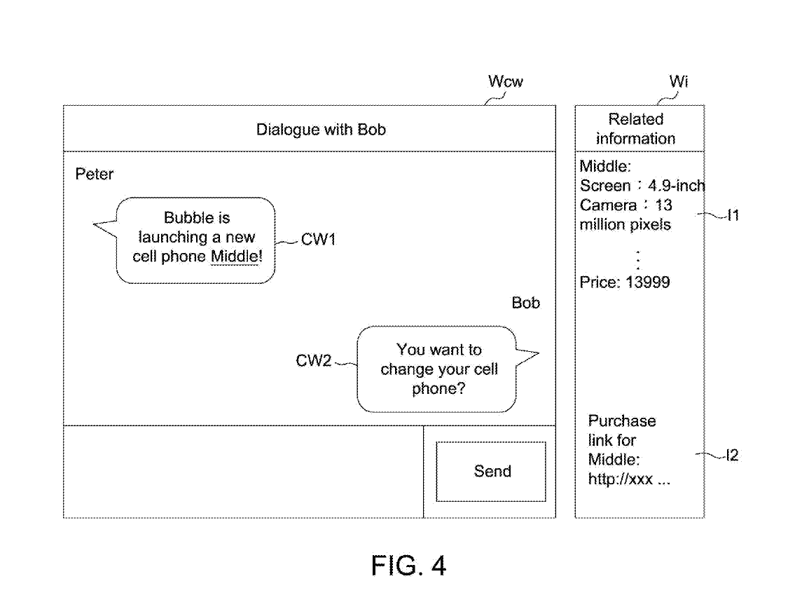

In the above embodiments, although the target text string is exemplified by the name of a television program, the scope of the present invention is not limited thereto. The target text string may be other names, e.g., the name of a place, a movie, a song, a person or an object. In the embodiment in FIG. 4, the target text string is the name of a cell phone “Middle” (i.e., the name of an object), the candidate text window Wcw is a dialogue window of a communication software application, and the candidate text paragraphs CW1 and CW2 are a dialogue of two users using the communication software application. In the embodiment, as “Middle” appears in the candidate text paragraph CW1, the related information window Wi shows related information of “Middle”. Similarly, in the embodiment, the related information may be in various types. For example, the information region I1 in the information window Wi shows specifications and price of the cell phone “Middle”, the information window I2 in the information window Wi shows a purchase link of the cell phone “Middle”, allowing the user to enter a page for purchasing the cell phone “Middle” by clicking on the link. It should be noted that, the related information Wi is not limited to showing the above types of information.

According to the foregoing embodiments, it is known that the candidate text paragraph may be presented in various forms (e.g., text in a communication software application, text on a webpage, or text of a document in an electronic device), the target text string may also be in various types (e.g., the name of a television program, place, movie, person or object), and the related information may also display various kinds of information (e.g., time, channel, price, broadcast link and purchase link). Thus, a user may adjust to obtain a most appropriate application method according to different requirements. Further, in the embodiments in FIG. 1 to FIG. 4, an example of a candidate text paragraph including a text string that is entirely the same as the target text string is given for illustration purposes. However, in other embodiments, the candidate text paragraph may include text that is partially the same as the target text string, with associated details to be described shortly.

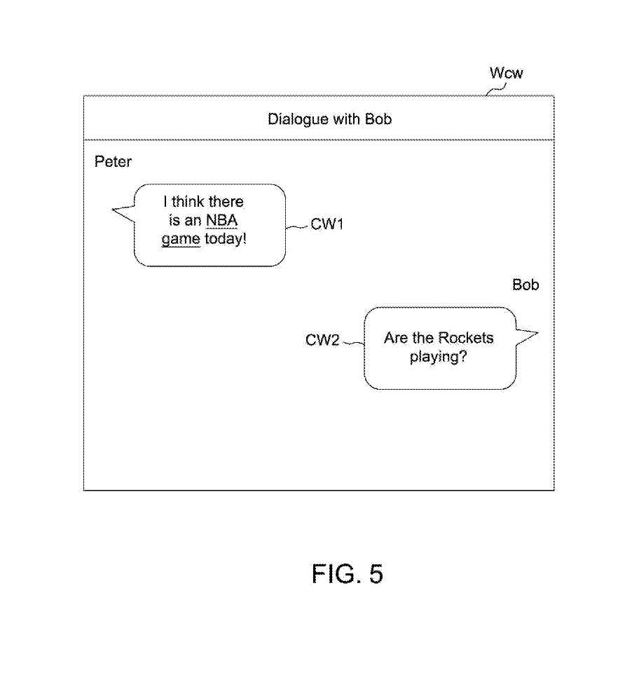

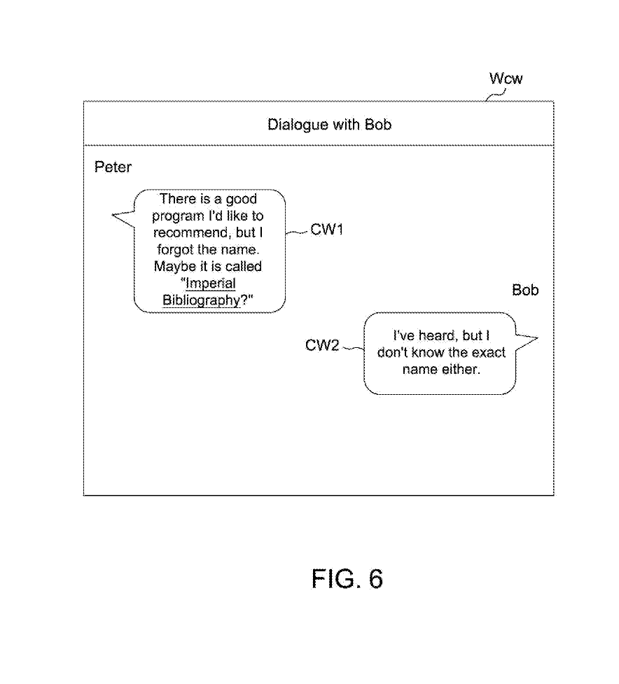

As previously stated, in order to trigger the display of related information, the candidate text paragraph is limited to including a text string that is entirely the same as the target text string. FIG. 5 and FIG. 6 show different similarity levels between a candidate text paragraph and a target text string according to embodiments, in which an example of a user dialogue of a communication software application is used for illustration. In the embodiment in FIG. 5, the target text string is the name of a television program “NBA game, Rockets vs. Spurs”. A user Peter mentions “NBA game”, and so only “NBA” and “game” match the target text string. A user Bob mentions “Are the Rockets playing?”, and so only the word “Rockets” matches the target text string. Therefore, each of the candidate text paragraphs CW1 and CW2 includes text that is partially the same as the target text string. Similarly, in FIG. 6, the target text string is “Bibliography of the Emperor”. The user Peter mentions “Bibliography of the Emperor”, and so the candidate text paragraph CW only includes a text string “Bibliography of the Emperor” that matches the target text string, whereas the candidate text paragraph CW2 does not include any text that matches the target text string. In the embodiments in FIG. 5 and FIG. 6, only text that is partially the same as the target text string is included, and the similarity levels are different. However, through appropriate settings of the similarity level, the display of related information can still be triggered when only a part of the candidate text paragraph is the same as the target text string.

The similarity level between the candidate text paragraph and the target text string may be determined according to different correlation coefficients. In one embodiment, the similarity level is determined according to a maximum word count of consecutive same words between the candidate text paragraph and the target text string. The maximum word count of consecutive same words is the word count of a longest consecutive same text string between the candidate text paragraph and the target text string. For example, in FIG. 5, the longest consecutive same text string between the candidate text paragraph CW1 and the target text string is “NBA game” that includes 2 words, and the longest consecutive text string between the candidate text paragraph CW2 and the target text string is “Rockets” that includes 1 words. From a collective perspective of the candidate text paragraphs CW1 and CW2, the word count of a longest consecutive same text string as the target text string is 2, i.e., the maximum word count of consecutive same words is 2. Thus, by setting a corresponding predetermined standard to 1, the display of the related information is triggered when the maximum word count of consecutive same words is 1. Thus, the display of the related information is triggered in the embodiment in FIG. 5.

In another embodiment, a ratio relationship between the maximum word count of consecutive same words and the word count of the target text string is used as a correlation coefficient for determining the similarity level. For example, in the embodiment in FIG. 5, the word count of consecutive same words is 3, the target text string is “NBA game, Rockets vs. Spurs”, and so the word count of consecutive same words is 2/5 (omitting punctuations and spaces) of the target text string. When a corresponding predetermined standard is set to 1/5, the display of the related information is triggered, such that the related information of the television program “NBA game, Rockets vs. Spurs” is displayed in the embodiment in FIG. 5. In contrast, when the corresponding predetermined setting is set to 3/5, the related information of the television program “NBA game, Rockets vs. Spurs” is not displayed in the embodiment in FIG. 5. The predetermined standard may be configured as desired according to requirements.

In another embodiment, the candidate text paragraph includes a first candidate text string and a second candidate text string, with each of the first candidate text string and the second candidate text string being the same as at least one word of the target text string. In the embodiment, the present invention detects a word count of words spaced between the first candidate text string and the second candidate text string to generate a spacing word count, and determines the similarity level according to the spacing word count. In FIG. 6, the candidate text paragraph includes a first candidate text string “Emperor” and a second candidate text string “Bibliography”, with a spacing word count in between. Thus, if the rule is set as “two candidate text strings may be regarded as a consecutive text string when the spacing word count is not greater than 2”, the embodiment in FIG. 6 may be regarded as having a maximum consecutive text string of 2. Thus, the spacing word count may also serve as a correlation coefficient for determining the similarity level. Further, the rule setting may also selectively omit the orders of the words in the target text string.

It should be noted that, the mechanisms for determining the similarity level may be jointly applied instead of being independently applied. Such combinations are encompassed within the scope of the present invention.

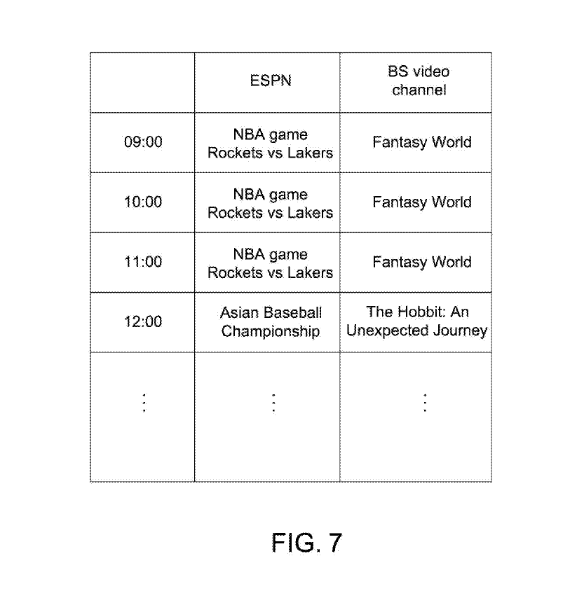

According to the embodiments of the present invention, the target text string is needed as a comparison basis, and a source for related information to be displayed is also required. Thus, the present invention includes a database for recording the target text string and related information, or a mechanism that real-time provides the target text string and related information. FIG. 7 shows a schematic diagram of related information of television programs. As shown in FIG. 7, the related information of television programs includes names of channels, and broadcast times of the television programs. In one embodiment, the data is stored in a storage device, or the related information may be real-time received from the external (e.g., real-time receiving the information through the Internet). According to the foregoing embodiments, the names of all the television programs are target text strings. When a candidate text paragraph appears, the similarity levels between the candidate text paragraph and the names of all the television programs are detected, and it is determined whether to display related information according to respective similarity levels. Alternatively, the names of a part of the television programs may be set as target text strings. In one embodiment, the related information of these television programs may be obtained from an electronic program guide (EPG). Details for obtaining the related information are generally known to one person skilled in the art. For example, the China Patent CN 101094335 discloses detailed steps for obtaining the related information from an EPG, and such details shall be omitted herein.

In some embodiments, a detection range may be defined, and the similarity level between only the candidate text paragraph located within the detection range and the target text string is automatically detected, or else the candidate text paragraph detected may be too broad. For example, when a certain webpage uses a small font, the webpage may include a large number of candidate text paragraphs. When a limited detection range is not defined, too many target text strings may be detected, and an excessively large amount of related information displayed may be difficult for a user to read. In one embodiment, the foregoing related information display method may be applied to an electronic device, which includes a screen whose display range is used as the detection range, and the similarity level between only all or a part of at least one candidate text paragraph in the detection range and the target text string is detected. For example, a certain webpage may include many pages, and the similarity level between only the candidate text paragraphs of the displayed page and the target text string is detected while leaving the pages not in display undetected. Alternatively, for an incomplete part included in at least one candidate text paragraph of a displayed page, only the incomplete part in the displayed page is detected.

In another embodiment, the detection range is defined by N periods, and the similarity level between only the candidate text paragraphs in the detection range and the target text string is automatically detected, where N is a positive integer. For example, following text is shown on a webpage:

“Bubble Corporation is hosting a product launch in New York tonight. The flagship model originally coded MX will be officially named as Middle. Middle has a metal body with an extremely fine texture and a more rounded contour, and provides a better hand feel compared to the last generation. A most distinctive feature of Middle is dual lens, which may shoot pseudo-3D photos and also support focusing after shooting.

Middle starts selling in the U.S. today, and will be sold, ahead of other Asia markets, in Taiwan on January 21^{st}. Pre-order is available from December 15th. The price for 16 GB Middle is NTD20,000. The price and market date for 32 GB are not yet announced. Middle is available in three colors—silver, gray and white.

Middle, the Taiwan version, carries a 6-inch monitor with a resolution of 1920×1080, four core processors, dual rear lens, 500 million pixel front lens, 2 GB memory, is available in 16 GB and 32 GB version, supports the expansion of micro SD card, and has a non-removable battery.”

When the detection range is defined according to two periods, only a part of the first candidate text paragraph “Bubble Corporation is hosting a product launch in New York tonight. The flagship model originally coded MX will be officially named as Middle.” is detected. It is detected whether this part of the first candidate text paragraph includes words that match the target text string while leaving the other part of the first candidate text paragraph undetected.

In another embodiment, the detection range is defined according to N empty lines. In continuation of the foregoing example, when the detection range is defined according to one empty line, only the first candidate text paragraph is detected; when the detection range is defined according two empty lines, the first candidate text paragraph and also the second candidate text paragraph “Middle starts selling in the U.S. today, and will be sold, ahead of other Asia markets, in Taiwan on January 21^{st}. Pre-order is available from December 15th. The price for 16 GB Middle is NTD20,000. The price and market date for 32 GB are not yet announced. Middle is available in three colors—silver, gray and white.” are detected. In another embodiment, the detection range is defined according to a word count. For example, when the detection range is limited to 100 words, the detection range then includes the entire first candidate text paragraph and a part of the second candidate text paragraph; when the detection range is limited to 200 words, the detection range then includes all of the candidate text paragraphs.

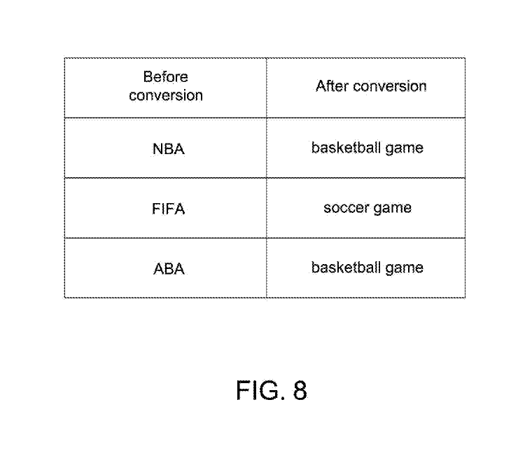

In one embodiment, at least one initial text paragraph may be converted into a candidate text paragraph according to a synonym database before the similarity level is detected. The synonym database also includes verbal inflection, verbal nominalization and other grammar corrections and translations. FIG. 8 shows a schematic diagram of a synonym database according to an embodiment of the present invention. As shown in FIG. 8, if the initial text paragraph (e.g., a dialogue in a communication software application or text on a webpage) includes “NBA” or “ABA”, “NBA” or “ABA” is converted into “basketball game” and then compared with the target text string. Similarly, if the initial text paragraph includes “FIFA”, “FIFA” is converted into “soccer game” and then compared with the target text string. It should be noted that, the conversion step may be displayed or not displayed. For example, if a user mentions “NBA” in the dialogue, the user may see that “NBA” is converted to “basketball game” and then compared with the target text string. Alternatively, the user may still see the text as “NBA”, and then see related information that is related information of “basketball game”

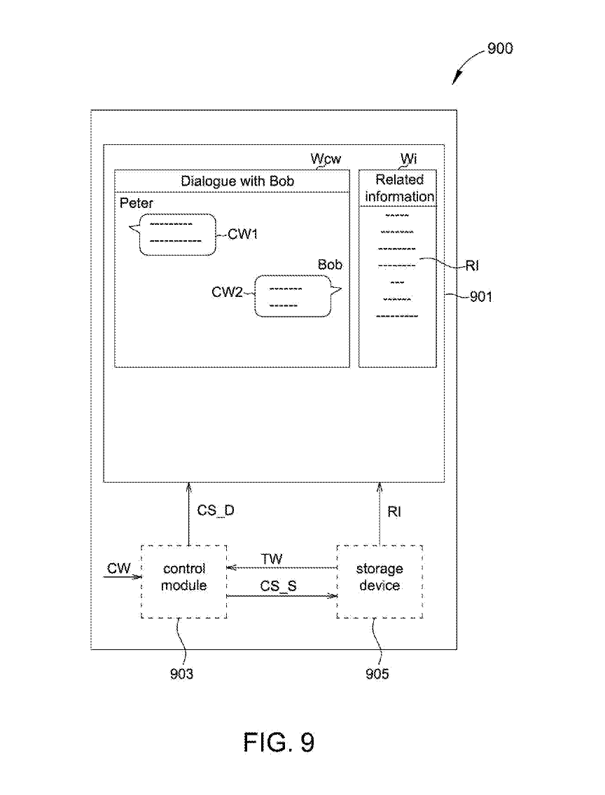

FIG. 9 shows an electronic device 900 according to an embodiment of the present invention. The electronic device 900 is capable of performing the foregoing related information display method. As shown in FIG. 9, the electronic device 900 includes a screen 901, a control module 903 and a storage device 905. The control module 903 receives a candidate text paragraph CW and causes the screen 901 to display at least a part of the candidate text paragraph CW. The control module 903 further controls the storage device 905 through a storage device control signal CS_S to receive a target text string TW from the storage device 905 and to compare the target text string TW with the candidate text paragraph CW, and controls the screen 901 according to the similarity level between the target text string TW and the candidate text paragraph CW through a display control signal CS_D to cause the screen 901 to display related information RI. It should be noted that, the storage device 905 is not limited to being disposed in the electronic device 900, and may be located outside the electronic device 900. Further, the related information RI and the target text string TW of the embodiment are not limited to being stored in the storage device in advance, and may be real-time received from the external. Thus, the storage device 905 may be replaced by an information receiving device. The electronic device 900 shown in FIG. 9 is capable of performing the foregoing embodiments, and associated details shall be omitted herein.

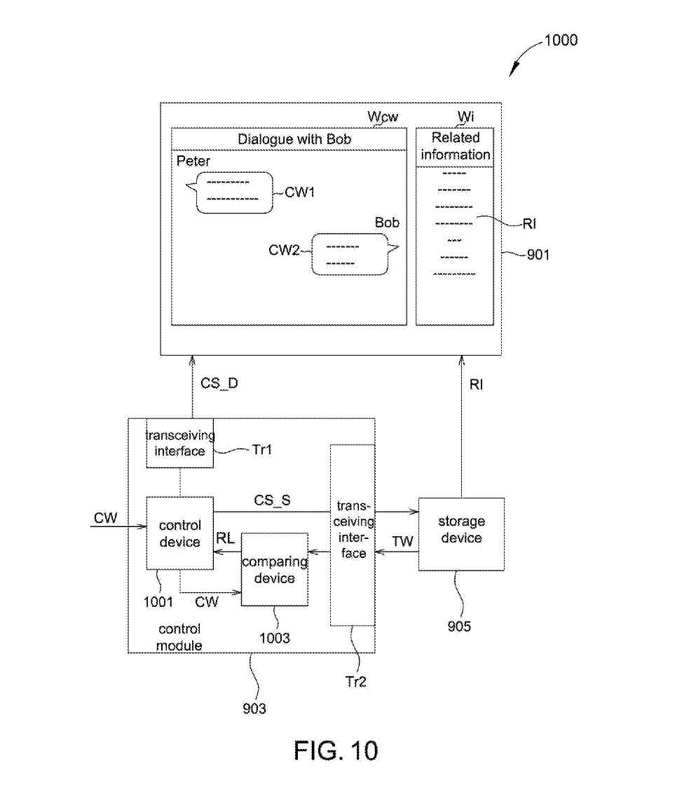

FIG. 10 shows a block diagram of a control module according to an embodiment of the present invention. As shown in FIG. 10, the control module 903 includes a control device 1001, a comparing device 1003 and transceiving interfaces Tr1 and Tr2. The comparing device 1003 transmits the storage device control signal CS_S to the storage device 905 via the transceiving interface Tr2, and receives the target text string TW from the storage device 905 via the transceiving interface Tr2. Further, the comparing device 1003 also receives the candidate text paragraph CW. It should be noted that, in one embodiment, the candidate text paragraph CW is from text displayed on the screen 901 and is first processed by the control device 1001, and so the candidate text paragraph CW is transmitted to the comparing device 1003 by the control device 1001. The comparing device 1003 compares the target text string TW with the candidate text paragraph CW to generate the similarity level RL, and transmits the similarity level RL to the control device 1001. After receiving the similarity level RL, the control device 1001 transmits the display control signal CS_D to the screen 901 via the transceiving interface Tr_1 to cause the screen 901 to display the related information RI. The screen 901 may directly receive the related information RI from the storage device 905, or may real-time receive the related information RI from the control device 1001.

The control device 1001 and the comparing device 1003 in FIG. 10 may be integrated into one device. For example, assuming the electronic device 900 in FIG. 9 is a cell phone, a program may be written into the electronic device 900 in FIG. 9, and the functions of the control device 1001 and the comparing device 1003 may be executed by an existing processor in the electronic device 900. Alternatively, the control device 1001 and the comparing device 1003 may be independent devices. For example, assuming the electronic device 900 in FIG. 9 is a cell phone, a program may be written into the electronic device 900 in FIG. 9, and the function of the control device 1001 may be executed by an existing processor in the electronic device 900, whereas the comparing device 1003 is a device including multiple logic components. The transceiving interfaces Tr1 and Tr2 may be integrated into one transceiving interface, or may be divided into more transceiving interfaces.

It should be noted that, the embodiment in FIG. 10 and associated details are an example for illustration purposes, and are not to be construed as a limitation to the present invention. Any device that is capable of achieving the function of the control device in FIG. 9 and FIG. 10 of the present invention is to be encompassed within the scope of the present invention.

According to the foregoing embodiments, the present invention provides a method and electronic device capable of automatically displaying related information, so as to allow a user to conveniently obtain required information or obtain a required website link. In addition, when the candidate text and the target text string are not exactly the same, the method and electronic device of the present invention are capable of automatically displaying related information. Thus, even when a user does not remember an entirely correct text string, correct related information can still be obtained.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A related information display method, comprising:
a) detecting a maximum word count of consecutive same words between at least one candidate text paragraph and a target text string to determine a similarity level; wherein, the maximum word count of consecutive same words is a word count of a longest consecutive same text string that the at least one candidate text paragraph has in the target text string, the candidate text paragraph is one of a dialogue in a communication software application, text on a webpage and text of a document in the electronic device, and the target text string is one of a name of a television program, a name of a place, a name of a movie, a name of a song, a name of a person and a name of an object; and
b) determining whether to display related information of the target text string according to the similarity level;
wherein, the related information is a website link associated with the target text string.

2. The related information display method according to claim 1, applied to an electronic device, the electronic device comprising a screen; before step (a), the method further comprising defining a display range of the screen as a detection range; wherein step (a) detects the similarity level between the at least one candidate text paragraph located only in the detection range and the target text string.

3. The related information display method according to claim 1, before step (a), further comprising defining a detection range according to N periods, wherein step (a) detects the similarity level between the at least one candidate text paragraph located only in the detection range and the target text string, where N is a positive integer.

4. The related information display method according to claim 1, before step (a), further comprising defining a detection range according to N empty lines, wherein step (a) detects the similarity level between the at least one candidate text paragraph located only in the detection range and the target text string, where N is a positive integer.

5. The related information display method according to claim 1, before step (a), further comprising defining a detection range according to a word count, wherein step (a) detects the similarity level between the at least one candidate text paragraph located only in the detection range and the target text string.

6. The related information display method according to claim 1, wherein step (a) comprises:
determining the similarity level according to a ratio relationship between the maximum word count of consecutive same words and a word count of the target text string.

7. The related information display method according to claim 1, wherein the at least one candidate text paragraph comprises a first candidate text string and a second candidate text string, each of the first candidate text string and the second candidate text string comprises at least one candidate word and is the same as at least one word of the target text string, and step (a) comprises:
detecting a word count of words spaced between the first candidate text string and the second candidate text string to generate a spacing word count; and
determining the similarity level according to the spacing word count.

8. The related information display method according to claim 1, further comprising converting at least one initial text paragraph to the candidate text paragraph according to a synonym database before performing step (a) and step (b).

9. An electronic device capable of automatically displaying related information, comprising:
a screen; and
a control module, coupled to the screen, configured to detect a maximum word count of consecutive same words between at least one candidate text paragraph and a target text string to determine a similarity level;
wherein, the maximum word count of consecutive same words is a word count of a longest consecutive same text string that the at least one candidate text paragraph has in the target text string; the candidate text paragraph is one of a dialogue in a communication software application, text on a webpage and text of a document in the electronic device, and the target text string is one of a name of a television program, a name of a place, a name of a movie, a name of a song, a name of a person and a name of an object.

10. The electronic device according to claim 9, wherein the control module utilizes the candidate text paragraph displayed on the screen as a detection range, and detects the similarity level between the at least one candidate text paragraph located only in the detection range and the target text string.

11. The electronic device according to claim 9, wherein the control module defines a detection range according to N periods, and detects the similarity level between the at least one candidate text paragraph located only in the detection range and the target text string, where N is a positive integer.

12. The electronic device according to claim 9, wherein the control module defines a detection range according to N empty lines, and detects the similarity level between the at least one candidate text paragraph located only in the detection range and the target text string, where N is a positive integer.

13. The electronic device according to claim 9, wherein the control module defines a detection range according to a word count, and detects the similarity level between the at least one candidate text paragraph located only in the detection range and the target text string.

14. The electronic device according to claim 9, wherein the control module determines the similarity level further according to a ratio relationship between the maximum word count of consecutive same words and a word count of the target text string.

15. The electronic device according to claim 9, wherein the at least one candidate text paragraph comprises a first candidate text string and a second candidate text string, each of the first candidate text string and the second candidate text string comprises at least one candidate word and is the same as at least one word of the target text string, and the control module detects a word count of words spaced between the first candidate text string and the second candidate text string to generate a spacing word count, and determines the similarity level according to the spacing word count.

16. The electronic device according to claim 9, wherein the control module converts at least one initial text paragraph to the candidate text paragraph according to a synonym database before detecting the similarity level between the candidate text paragraph and the target text string, and displays the related information according to the similarity level.
